(19) United States
(12) Patent Application Publication
(10) Pub. No.: US 2024/0149556 A1
(43) Pub. Date: May 9, 2024

(54) CAP SHEETS USEFUL FOR FUNCTIONAL FILMS

(71) Applicant: EASTMAN CHEMICAL COMPANY, KINGSPORT, TN (US)

(72) Inventors: BABATUNDE SAMUEL OLAIYA, GREENSBORO, NC (US); JAMIE SUE DZICZKOWSKI, KINGSPORT, TN (US); SUNIL VILAS KULKARNI, KINGSPORT, TN (US); THOMAS JOSEPH PECORINI, KINGSPORT, TN (US); LUKE AARON KANODE, AXTON, VA (US)

(73) Assignee: EASTMAN CHEMICAL COMPANY, KINGSPORT, TN (US)

(21) Appl. No.: 18/547,541

(22) PCT Filed: Feb. 17, 2022
(86) PCT No.: PCT/US2022/016715

§ 371 Date: Aug. 23, 2023

Related U.S. Application Data
(60) Provisional application No. 63/154,058, filed on Feb. 26, 2021.

(51) Int. Cl. B32B 7/02; B32B 7/12; B32B 27/08; B32B 27/36; B32B 27/40; C09J 11/06; C09J 11/08; C09J 127/12

(52) U.S. Cl. CPC B32B 7/02; B32B 7/12; B32B 27/08; B32B 27/36; B32B 27/40; C09J 11/06; C09J 11/08; C09J 127/12; B32B 2255/10; B32B 2255/26; B32B 2274/00; B32B 2307/748

(57) ABSTRACT

Functional film systems are disclosed that include a functional film having a surface energy; and a cap sheet, adjacent to the functional film, having a surface energy. In aspects, the ratio of the surface energy of the cap sheet to the functional film, measured at a point where the cap sheet contacts the functional film, is no greater than 2.6; and the peel strength may be from about 1 to about 50.

### BACKGROUND OF INVENTION

Films are commonly applied to articles to add functionality to the articles. Examples of such functionality might be to provide a color or image, or to protect the article from environmental damage (scratching, chemical attack, etc.). These “functional films” include Decorative Films, Paint Protection Films, Window Films, etc. Quite often, these functional films possess a coating that provides some or all the functionality. To prevent the functional film (or its coating) from being damaged prior to installation on the article, a second film commonly referred to as a “cap sheet” is often applied on top of a functional film, that is, on top of the coating. This cap sheet is then removed immediately prior to installation. To facilitate removal of the cap sheet, the adhesive strength between the cap sheet and the mating surface on the functional film, measured as peel strength, should be as low as possible while still retaining sufficient adhesion.

Occasionally, a functional film may be created whose surface (film or coating) is so hydrophobic that traditional cap sheets will not adhere to it. In these situations, a special cap sheet must be developed that contains an adhesive layer. However, such a cap sheet can adhere so strongly that it cannot be easily removed during installation. It would be desirable to have a cap sheet with reduced peel strength of the adhesive layer, while maintaining sufficient adhesion prior to use.

### SUMMARY OF INVENTION

In one aspect, the invention relates to a functional film system, comprising: a functional film having a surface energy; and a cap sheet, adjacent to the functional film, having a surface energy, wherein the ratio of the surface energy of the cap sheet to the functional film, measured at a point where the cap sheet contacts the functional film, is no greater than 2.6; and wherein the peel strength is from about 1 to about 50.

Further aspects of the invention are as disclosed and claimed herein.

### DETAILED DESCRIPTION OF THE INVENTION

Thus, in one aspect, the invention relates to functional film systems that include a functional film having a surface energy, and a cap sheet, adjacent to the functional film, having a surface energy. In one aspect, the ratio of the surface energy of the cap sheet to the functional film, measured at a point where the cap sheet contacts the functional film, is no greater than 2.6; and

wherein the peel strength is from about 1 to about 50 lb/in.

In a further aspect, the cap sheet may comprise a cap sheet substrate, and a cap sheet adhesive layer, adjacent to the functional film, which has the surface energy. In this aspect, the cap sheet adhesive layer assists in maintaining contact between the functional film and the cap sheet.

In one aspect, the ratio of the surface energy of the cap sheet to the functional film, measured at a point where the cap sheet contacts the functional film, is from about 0.1 to about 2.6, or from 0.1 to 2.5, or from 0.2 to 2.

In one aspect, the cap sheet adhesive layer comprises a surface-energy-modifying additive, for example one or more of: a fluoropolymer, a silicon-containing polymer, or an inorganic nanoparticle. In further aspects, the surface-energy-modifying additive comprises one or more of: a polydimethylsiloxane, a polytetrafluoroethylene, a polyethylene, a polypropylene, an oxidized polyethylene, or an oxidized polypropylene.

In a further aspect, the surface-energy-modifying additive may comprise one or more polyether siloxane copolymers.

In various aspects of the invention, the functional film may comprise a functional film substrate and a top coat, and wherein the top coat comprises a surface-energy-modifying additive.

Adhesion is understood to be related to the surface energy, or surface tension, which affects wetting. Good adhesion is thus derived from good wetting. That is, in general, for good substrate wetting, it is understood that the surface tension of the coating material should be lower than the surface tension of the substrate, or they should at least be equal. See A. Butt, et al., Theory of Adhesion and its Practical Implications, Journal of Faculty of Engineering & Technology, 2007-2008, Pages 21-45. In the present invention, then, the cap sheet serves as the coating, and the functional film is the substrate. In other words, stronger adhesion is understood to occur when the ratio is low. According to one aspect of the invention, we have unexpectedly discovered that, contrary to traditional understandings, desirably reduced peel strength can be obtained with a cap sheet even when the ratio of surface energies is relatively low.

Thus, we have found that certain additives, defined as siloxane copolymers, more specifically polyether siloxane copolymers, most specifically TEGO Glide 410, can be incorporated into a cap sheet structure to reduce peel strength even when the ratio in surface energy between the mating surfaces of the functional film and cap sheet are relatively low. Use of this class of additives allows for superior release of cap sheets from a wider variety of functional films.

We have also surprisingly found, with respect to these siloxane copolymers, that the surface energy increases when these are added. One skilled in the art would have expected just the opposite. In fact, when a surface-energy-modifying additive is added to the top coat of the functional film, the surface energy decreases as expected.

Silicone polymers, in general, exhibit very low surface energies owing to their flexible backbone that is well protected by systematically arranged methyl groups along the backbone. Silicone copolymers are designed to impart a slight incompatibility and hence enable migration to the surface of a coating or an adhesive they are mixed in.

Thus, for example, surface energies of the top coats of the functional films described herein, comprising siloxane copolymer-based additive, are always significantly lower than those without the additive, irrespective of the top coat ingredients.

As used herein, the term “polymer” includes copolymers, since many of the polymers useful according to the invention are not homopolymers.

In various aspects the functional films may be any films that serves a useful function. For example, the films may be protective films, decorative films, paint protection films, window films, autowraps, and the like. For purposes of the invention, any functional film may be used in which a cap sheet is desirable.

Functional films according to the invention typically comprise a functional film substrate such as further described below.

Thus, in one aspect, the functional film may comprise a 2-20 mil thick base polymer film (referred to herein as a “functional film substrate”), optionally onto which a 2-20 micron thick coating may be applied. The functional film may also have an optional mounting adhesive layer on the side of the base polymer film opposite the coating. Preferred functional films are Paint Protection Films, which often comprise a thermoplastic urethane as the substrate, a Pressure Sensitive Adhesive (PSA) as the adhesive layer, and an optional coating. When the coating exists, it may comprise an acrylic or polyester thermoset material.

Cap sheets are films attached to the surface of a functional film during manufacture to protect the surface of the functional film prior to installation and use. Cap sheets need to have enough adhesion to the functional film so that it does not detach after manufacture, during storage and handling, but can be detached easily enough by a customer when the functional film is installed in its final use. The process used to attach the two films together is commonly referred to as “nipping” and involves pressing the two films together between two rolls under pressure. Cap sheets are typically crystalline films based on paper, polymer-coated paper, polyester, particularly biaxially oriented polyethylene terephthalate (bo-PET), polypropylene (PP), high density polyethylene (HDPE) or other olefins. Other polymers might also be used as a cap sheet, as further described herein.

When the functional film is extremely hydrophobic, a traditional cap sheet may not adhere to the functional film when nipped during manufacture. In this case, the cap sheet needs to be designed with an adhesive layer to improve adhesion. However, if this adhesion is too high, it may become difficult to remove during its intended application, as further described below. Thus, relatively low peel strength may well be desirable in such cases.

### Cap Sheet Adhesive Layer

Unless the cap sheet itself is adhesive, the cap sheet will typically be provided with an adhesive layer, typically a pressure sensitive adhesive. The films of the invention may thus further comprise a pressure sensitive adhesive (PSA), provided to assist in mounting the cap sheet to the surface of the functional film to which they are to be adhered. These pressure sensitive adhesives may be applied, for example, by means of a release liner, or may be coated onto the thermoplastic elastomeric substrates. Pressure sensitive adhesives useful according to the invention include those disclosed in U.S. Pat. No. 5,883,149, the disclosure of which is incorporated herein by reference in its entirety.

The PSAs useful according to the invention include acrylate pressure sensitive adhesives that include acrylic polymers that may be characterized by their glass transition temperature (Tg). The Tg of the polymer may be from about −55° C. to about 15° C., or from −30° C. to 5° C., or from −25° C. to 0° C. The adhesives according to the invention may comprise from about 25 to about 98 parts, or from 60 to 95 parts, of an acrylic acid ester whose homopolymer has a Tg less than 0° C., or especially less than −20° C.; from about 2 to about 75 parts, or from 5 to 45 parts of an ethylenically unsaturated monomer whose homopolymer has a Tg greater than 0° C., or greater than 10° C.; from 0 to about 15 parts, or from 0 to 10 parts, of an acid- or hydroxyl-bearing polar ethylenically unsaturated monomer. Optionally the adhesive polymer may be blended with a tackifier from 0 to about 50 parts, or from 10 to 30 parts.

The acrylic acid esters that are useful according to the invention are monofunctional acrylic esters of monohydric alcohols having from about 4 to about 18 carbon atoms in the alcohol moiety, whose homopolymer has a Tg less than 0° C. Included in this class of acrylic acid esters are isooctyl acrylate, 2-ethylhexyl acrylate, isononyl acrylate, isodecyl acrylate, decyl acrylate, lauryl acrylate, hexyl acrylate, butyl acrylate, and octadecyl acrylate, or combinations thereof. In the case of octadecyl acrylate, the amount is chosen such that side chain crystallization does not occur at room temperature.

Examples of ethylenically unsaturated monomers whose homopolymer has a Tg greater than 0° C., or greater than 10° C., include, but are not limited to, 3,3,5 trimethylcyclohexyl acrylate, cyclohexyl acrylate, isobornyl acrylate, N-octyl acrylamide, t-butyl acrylate, methyl methacrylate, ethyl methacrylate, propyl methacrylate, N,N dimethylacrylamide, N-vinyl-2-pyrrolidone, N-vinyl caprolactam, acrylonitrile, tetrahydrofurfuryl acrylate, glycidyl acrylate, 2-phenoxyethylacrylate, and benzylacrylate or combinations thereof.

Acid or hydroxyl bearing monomers useful according to the invention include, but are not limited to, acrylic acid, methacrylic acid, methyl acrylate, betacarboxyethyl acrylate, hydroxyethyl acrylate, hydroxyethyl methacrylate, hydroxypropyl acrylate, hydroxypropyl methacrylate, hydroxybutyl acrylate, and hydroxybutyl methacrylate.

These adhesive polymers will optionally include a cross-linker including, but not limited, to metal chelates like aluminum acetylacetonate, and various titanates. Other crosslinkers include, but are not limited to, multifunctional epoxies, silanes, aziridines, isocyanates and/or (meth)acrylates. Optionally the PSA could also include other additives such as tackifiers, plasticizers, UV absorbers/stabilizers, and antioxidants.

We note that the functional film, when used for example as an exterior or interior window film or paint protection film, may additionally have provided on its bottom a means for adhering the functional film to a window or automobile surface, that is, a mounting adhesive. This adhesive layer can be comprised of any adhesive that is suitable for bonding the substrate to a window, including the PSAs described above. When being bonded to a window, pressure sensitive adhesives may be preferable, with an acrylic-based adhesive being particularly preferable. Loctite Duro-Tak 109A (available from Henkel) is an example of such an adhesive. The mounting adhesive layer may also have a release liner attached thereto. The release liner advantageously provides a release effect against the sticky adhesive layer. The release liner in the depicted embodiment can comprise any polyethylene terephthalate (PET) film with a silicone release coating that can be peeled from the adhesive layer leaving the adhesive layer on the base substrate. Alternatively, the adhesive and release layers may comprise a clear distortion-free adhesive with a polypropylene liner.

In one aspect, the cap sheet substrate may be a structure comprising a 2-20 mil thick base polymer film, preferably biaxially oriented PET, optionally onto which a 2-20 micron thick cap sheet adhesive layer is applied. Various additives might be included directly into the film or into the adhesive. For this invention, siloxane copolymers, more specifically polyether siloxane copolymers, most specifically TEGO Glide 410, are incorporated into the cap sheet, and more specifically may be added into the adhesive layer.

Cap sheets containing adhesive layers are distinct from films referred to as “release films/layers”. Release films are designed to be in contact with an adhesive layer on a functional film, but release films are designed to be easily separated (i.e. released) from the adhesive layer of the functional film during use. With cap sheets containing adhesive layers, the adhesive is intended to remain with the cap sheet after separation.

Surface energy is the excess energy associated with the presence of a surface and can strongly affect strength of the adhesive forces between two mating surfaces. Adhesive forces between two mating surface are generally strong when the ratio of cap sheet surface energy to functional film surface energy is low. But for a cap sheet to be easily peelable, low ratios are generally understood to be undesirable.

Surface energy is comprised of a dispersion and a polar component. It is generally measured per ASTM D7490 wherein contact angles of a surface with water and diiodomethane are converted into dispersion and polar components using Owens-Wendt-Kaelble equation. The sum of these components is the total surface energy.

Peel resistance is determined in terms of the force needed to peel back an adhesive layer from a solid surface at a defined rate in a defined peel angle, or to peel apart two films. According to one aspect of the invention, relatively low peel strengths are desirable.

Surface-energy-modifying additives useful according to the invention include hydrocarbon polymers and copolymers, and especially fluoropolymers and silicon-containing polymers and copolymers; and inorganic nanoparticles.

The surface-energy-modifying additives exemplified in the present application are siloxane copolymers, or more generally silicone polymers. Siloxane polymers and copolymers are a general class of polymers that contain . . . O—Si—O—Si . . . bonds in their backbone. One such example is polydimethylsiloxane, with the structure shown below.

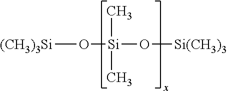

It is also common to modify the structure by adding polyether side chains, as shown below. Such polymers are commonly referred to as polyether siloxane copolymers.

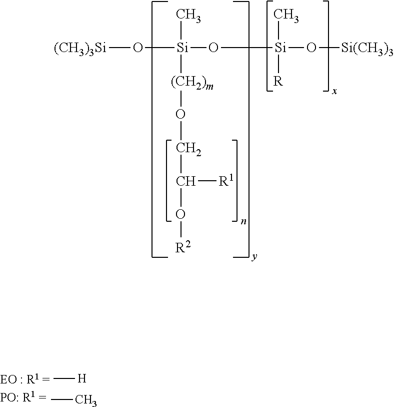

These silicone-containing copolymers additives may be used in amounts, for example, from about 0.01 to about 10 wt %, or from 0.02 to 7.5 wt. %, or from 0.05 to 5 wt. %, by weight of the film or layer in which they are dispersed.

Other useful surface-energy-modifying additives include fluoropolymers that are fluorosurfactants, such as perfluoroalkyl-containing surfactants that generally achieve low surface tension with smaller amounts compared to generally-used hydrocarbon and silicone-containing surfactants. These fluoropolymer additives may be used in amounts, for example, from about 0.01 to about 10 wt %, or from 0.02 to 7.5 wt. %, or from 0.05 to 5 wt. %, by weight of the film or layer in which they are dispersed.

Anther useful surface-energy-modifying additives include polymers including silicone polymers such as polydimethylsiloxane, fluoroalkyl polymers such as polytetrafluoroethylene, polyethylene, polypropylene, oxidized polyethylene, and oxidized polypropylene. These silicone additives may be used in amounts, for example, from about 0.01 to about 10 wt %, or from 0.02 to 7.5 wt. %, or from 0.05 to 5 wt. %, by weight of the film or layer in which they are dispersed.

Yet another class of surface-energy-modifying additives include nanoparticles of oxides of metals including, but not limited to, silica, zinc, titanium. These additives impart texture and hence, hydrophobicity, to a coating, by migrating to the surface. These nanoparticles may be used in amounts, for example, from about 0.01 to about 10 wt %, or from 0.02 to 7.5 wt. %, or from 0.05 to 5 wt. %, by weight of the film or layer in which they are dispersed.

According to the functional film systems of the invention, either the functional film, the cap sheet, or both the functional film and the cap sheet, typically comprise a substrate, which may comprise any one or more of the following polymers.

There are three main chemical classes of TPU: Polyester, Polyether and Polycaprolactone. Polyester TPU's are compatible with PVC and other polar plastics and provide excellent abrasion resistance, offer a good balance of physical properties and are useful in polymer blends. Polyether TPU's offer lower temperature flexibility and good abrasion and tear resistance. They also have good hydrolytic stability. Polycaprolactone TPU's have the inherent toughness and resistance of polyester based TPU's and good low temperature performance and hydrolytic stability.

TPU's can also be subdivided into Aromatic and Aliphatic versions. Aromatic TPU's based on isocyanates like TDI and MDI are the majority of TPU's and are used when strength, flexibility and toughness are required. They typically do not weather well. Aliphatic TPU's based on isocyanates like H12 MDI, HDI and IPDI are light stable and offer excellent clarity. They are commonly used in automotive interior and exterior applications and are often used to bond safety glass together. Aliphatic Polycaprolactone TPU's offer the best balance of weatherability, low temperature flexibility and impact resistance needed for many automotive exterior applications.

Polyvinyl butyral (PVB) is a clear, colorless, amorphous thermoplastic obtained by condensation reaction of polyvinyl alcohol and butyraldehyde. The resin is known for its excellent flexibility, film-forming and good adhesion properties as well as outstanding UV resistance. The properties of PVB like its solubility in solvents and compatibility with binders and plasticizers depend on the degree of acetalization and polymerization. An increase of the number of butyral groups in the polymer usually improves the water resistance of PVB films. PVB can also be cross-linked. Its cross-linking capacity depends on the number of residual OH groups in the polymer which can undergo condensation reactions with phenolic, epoxy, and melamine resins as well as with isocyanates. These chemical modifications produce high quality solvent resistant PVB coatings and films. One of the major uses of PVB films is safety glass. Due to PVB's good adhesion to glass, most of the splinters of fractured glass will adhere to the surface of the PVB film and thus prevent personal injury by large and sharp glass fragments. PVB laminated glass also offers an improved sound barrier, good impact resistance, and almost 100% absorption of UV light. The latter is important for the protection of interiors from fading due to UV exposure.

Ethylene-vinyl acetate (EVA), also known as poly (ethylene-vinyl acetate) (PEVA), is the copolymer of ethylene and vinyl acetate. The weight percent of vinyl acetate usually varies from 10 to 40%, with the remainder being ethylene. The EVA copolymer which is based on a low proportion of VA (approximately up to 4%) may be referred to as vinyl acetate modified polyethylene. It is a copolymer and is processed as a thermoplastic material. It has some of the properties of a low-density polyethylene but increased gloss (useful for film), softness and flexibility. The material is generally considered non-toxic. The EVA copolymer which is based on a medium proportion of VA (approximately 4 to 30%) is referred to as thermoplastic ethylene-vinyl acetate copolymer and is a thermoplastic elastomer material. It is not vulcanized but has some of the properties of a rubber or of plasticized polyvinyl chloride particularly at the higher end of the range. Both filled and unfilled EVA materials have good low temperature properties and are tough. The materials with approximately 11% VA are used as hot melt adhesives. The EVA copolymer which is based on a high proportion of VA (greater than 60%) is referred to as ethylene-vinyl acetate rubber. EVA is an elastomeric polymer that produces materials which are “rubber-like” in softness and flexibility. The material has good clarity and gloss, low-temperature toughness, stress-crack resistance, hot-melt adhesive waterproof properties, and resistance to UV radiation. EVA has a distinctive vinegar-like odor and is competitive with rubber and vinyl polymer products in many electrical applications.

Poly(cyclohexylene dimethylene cyclohexanedicarboxylate), glycol and acid comonomer (PCCE) is an elastomer is a high molecular weight semi crystalline thermoplastic copolyester ether elastomer manufactured by the reaction of dimethylcyclohexane dicarboxylate with cyclohexane dimethanol and polytetramethylene glycol. PCCE has high flexibility without plasticizers, very high clarity, excellent toughness and puncture resistance, outstanding low temperature strength and excellent flex crack & creep resistance.

The invention relates to the use of blends that comprise thermoplastic polyurethanes, or TPUs. TPUs can be divided into three chemical classes: polyester-based, polyether-based, and polycaprolactone-based, typically referring to the polyols that are reacted with diisocyanates to form the polyurethane. Polyester TPUs are generally compatible with PVC and other polar plastics and provide excellent abrasion resistance, offer a good balance of physical properties and are useful in polymer blends. Polyether-based TPUs offer lower temperature flexibility and good abrasion and tear resistance. They also have good hydrolytic stability. Polycaprolactone-based TPUs have the inherent toughness and resistance of polyester-based TPU's and good low temperature performance and hydrolytic stability.

TPUs can also be subdivided into aromatic and aliphatic TPUs, in this case referring to the diisocyanates used. Aromatic TPU's based on isocyanates like toluene diisocyanate (TDI) and methylene diphenyl diisocyanate (MDI) are the majority of TPU's and are used when strength, flexibility, and toughness are required. However, they typically do not weather well. Aliphatic TPUs based on isocyanates like (4,4′-Methylene dicyclohexyl diisocyanate (H12 MDI), hexamethylene diisocyanate (HDI) and isophorone diisocyanate (IPDI) are light stable and offer excellent clarity. They are commonly used in automotive interior and exterior applications and may be used to bond safety glass together. We have found that aliphatic polycaprolactone-based TPU's offer a good balance of weatherability, low temperature flexibility, and impact resistance needed for many automotive exterior applications, and are especially useful according to the invention.

In a specific aspect, the thermoplastic polyurethanes useful according to the invention are aliphatic polycaprolactone-based thermoplastic polyurethanes, comprised of a polycaprolactone-based polyol reacted with an aliphatic diisocyanate. In this aspect, the aliphatic diisocyanate may be selected from, for example, (4,4′-Methylene dicyclohexyl diisocyanate (H12 MDI or HMDI), hexamethylene diisocyanate (HDI), and isophorone diisocyanate (IPDI). In this aspect, the polycaprolactone-based polyol is comprised of caprolactone units, a glycol such as ethylene glycol, propylene glycol, neopentyl glycol, or butanediol, and may be initiated by a glycol such as ethylene glycol, diethylene glycol, hexanediol, neopentyl glycol or butane diol. In a preferred aspect, the thermoplastic polyurethane comprises residues of HMDI, 1,4-butanediol, and caprolactone. The polycaprolactone-based polyol used to form the thermoplastic polyurethanes of the invention may have a molecular weight, for example, from about 400 to about 4000, or from 600 to 2500, or from 800 to 2000.

In this aspect, the aliphatic polycaprolactone-based thermoplastic polyurethanes useful according to the invention have a Tg from about 50° C. to about −50° C., or from 35° C. to about −25° C., as measured by Differential Scanning calorimetry or Dynamic Mechanical Thermal Analysis.

Other properties of the aliphatic polycaprolactone-based thermoplastic polyurethanes include the inherent toughness and resistance of polyester-based TPUs and good low temperature performance, good weatherability and light fastness and hydrolytic stability.

TPUs more generally include those disclosed and claimed in U.S. Pat. No. 10,265,932, the disclosure of which is incorporated herein by reference. They are polymers containing urethane (also known as carbamate) linkages, urea linkages, or combinations thereof (i.e., in the case of poly(urethane-urea)s). Thus, polyurethanes useful according to the invention contain at least urethane linkages and, optionally, urea linkages. In one aspect, polyurethane-based layers of the invention are based on polyurethanes where the backbone has at least about 80% urethane and/or urea repeat linkages formed during their polymerization.

TPUs useful according to the invention can include polyurethane polymers of the same or different chemistries, that is, polymer blends. Polyurethanes generally comprise the reaction product of at least one isocyanate-reactive component, at least one isocyanate-functional component, and one or more optional components such as emulsifiers and chain extending agents.

Isocyanate-reactive components include at least one active hydrogen, such as amines, thiols, and polyols, and especially hydroxyl-functional materials such as polyols that provide urethane linkages when reacted with the isocyanate-functional component. Specific polyols of interest include polyester polyols (e.g., lactone polyols) and alkylene oxide adducts thereof (e.g., ethylene oxide; 1,2-epoxypropane; 1,2-epoxybutane; 2,3-epoxybutane; isobutylene oxide; and epichlorohydrin), polyether polyols (e.g., polyoxyalkylene polyols, such as polypropylene oxide polyols, polyethylene oxide polyols, polypropylene oxide polyethylene oxide copolymer polyols, and polyoxytetramethylene polyols; polyoxycycloalkylene polyols; polythioethers; and alkylene oxide adducts thereof), polyalkylene polyols, polycarbonate polyols, mixtures thereof, and copolymers thereof. Further polyols of interest are those derived from caprolactone, referred to herein as polycaprolactone-based polyols.

The isocyanate-reactive component is thus reacted with an isocyanate-functional component to form the polyurethane. The isocyanate-functional component may contain one isocyanate-functional material or mixtures thereof. Polyisocyanates, including derivatives thereof (e.g., ureas, biurets, allophanates, dimers and trimers of polyisocyanates, and mixtures thereof), (hereinafter collectively referred to as “polyisocyanates”) are preferred isocyanate-functional materials for the isocyanate-functional component. Polyisocyanates have at least two isocyanate-functional groups and provide urethane linkages when reacted with the hydroxy-functional isocyanate-reactive components. In one embodiment, polyisocyanates useful for preparing polyurethanes are one or a combination of any of the aliphatic or optionally aromatic polyisocyanates used to prepare polyurethanes.

The isocyanates are typically diisocyanates, and include aromatic diisocyanates, aromatic-aliphatic diisocyanates, aliphatic diisocyanates, cycloaliphatic diisocyanates, and other compounds terminated by two isocyanate-functional groups (e.g., the diurethane of toluene-2,4-diisocyanate-terminated polypropylene oxide polyol). Diisocyanates useful according to the invention thus include: 2,6-toluene diisocyanate; 2,5-toluene diisocyanate; 2,4-toluene diisocyanate; phenylene diisocyanate; 5-chloro-2,4-toluene diisocyanate; 1-chloromethyl-2,4-diisocyanato benzene; xylylene diisocyanate; tetramethyl-xylylene diisocyanate; 1,4-diisocyanatobutane; 1,6-diisocyanatohexane; 1,12-diisocyanatododecane; 2-methyl-1,5-diisocyanatopentane; methylenedicyclohexylene-4,4′-diisocyanate; 3-isocyanatomethyl-3,5,5′-trimethylcyclohexyl isocyanate (isophorone diisocyanate); 2,2,4-trimethylhexyl diisocyanate; cyclohexylene-1,4-diisocyanate; hexamethylene-1,6-diisocyanate; tetramethylene-1,4-diisocyanate; cyclohexane-1,4-diisocyanate; naphthalene-1,5-diisocyanate; diphenylmethane-4,4′-diisocyanate; hexahydro xylylene diisocyanate; 1,4-benzene diisocyanate; 3,3′-dimethoxy-4,4′-diphenyl diisocyanate; phenylene diisocyanate; isophorone diisocyanate; polymethylene polyphenyl isocyanate; 4,4′-biphenylene diisocyanate; 4-isocyanatocyclohexyl-4′-isocyanatophenyl methane; and p-isocyanatomethyl phenyl isocyanate.

Aliphatic isocyanates useful according to the invention thus include aliphatic groups that may be alkyl groups, alkenyl groups, alkynyl groups, and the like, and may be branched or linear, with linear being advantageous. Examples include 1,12-diisocyanatododecane; 2-methyl-1,5-diiso¬icyana¬itopentane; methylene¬idicyclohexylene-4,4′-diisocyanate; 3-isocyanatomethyl-3,5,5′-trimethyl¬cyclohexyl isocyanate (isophorone diisocyanate); 2,2,4-trimethylhexyl diisocyanate; cyclohexylene-1,4-diisocyanate; hexamethylene-1,6-diisocyanate; tetramethylene-1,4-diisocyanate; cyclohexane-1,4-diisocyanate; and isophorone diisocyanate.

One or more chain extenders can also be used in preparing the TPUs of the invention, or the TPU/copolyester ether blends of the invention. For example, such chain extenders can be any or a combination of the aliphatic polyols, aliphatic polyamines, or aromatic polyamines used to prepare polyurethanes. Chain extenders useful according to the invention thus include the following: 1,4-butanediol; propylene glycol; ethylene glycol; 1,6-hexanediol; glycerin; trimethylolpropane; pentaerythritol; 1,4-cyclohexane dimethanol; and phenyl diethanolamine. Also note that diols such as hydroquinone bis(β-hydroxyethyl)ether; tetrachlorohydroquinone-1,4-bis(β-hydroxyethyl)ether; and tetrachlorohydroquinone-1,4-bis(β-hydroxyethyl)sulfide, even though they contain aromatic rings, are considered to be aliphatic polyols for purposes of the invention. Aliphatic diols of 2-10 carbon atoms are preferred. Especially preferred is 1,4-butanediol.

Poly(cyclohexylene dimethylene cyclohexanedicarboxylate), glycol and acid comonomer (PCCE) is a high molecular weight semi crystalline thermoplastic copolyester ether elastomer manufactured by the reaction of dimethylcyclohexane dicarboxylate with cyclohexane dimethanol and polytetramethylene glycol. PCCE has high flexibility without plasticizers, very high clarity, excellent toughness and puncture resistance, outstanding low temperature strength and excellent flex crack & creep resistance.

The invention thus relates to the use of blends that comprise copolyester ethers that are elastomers, and especially elastomers that are high molecular weight semi-crystalline thermoplastic copolyester ethers manufactured by the reaction of dimethylcyclohexane dicarboxylate with cyclohexane dimethanol and polytetramethylene glycol. The copolyester ethers useful according to the invention have high flexibility without plasticizers, very high clarity, excellent toughness and puncture resistance, outstanding low temperature strength, and excellent flex, crack, and creep resistance.

Copolyester ethers useful according to the invention include those disclosed in U.S. Pat. Nos. 4,349,469 and 4,939,009, the disclosures of which are incorporated herein by reference. The copolyester ethers useful according to the invention are tough, flexible materials that can be extruded into clear sheets. They include copolyester ethers based on 1,4-cyclohexanedicarboxylic acid or an ester thereof, 1,4-cyclohexanedimethanol, and poly(oxytetramethylene) glycol, also known as polytetramethylene ether glycol. The copolyester ethers useful according to the invention include those available commercially from Eastman Chemical Company, Kingsport, TN, under the ECDEL brand.

In one aspect, the copolyester ethers may have an Inherent Viscosity (I.V.), for example, from about 0.8 to 1.5, and recurring units from (1) a dicarboxylic acid component comprising 1,4-cyclohexanedicarboxylic acid or an ester thereof typically having a trans isomer content of at least 70%, or at least 80%, or at least 85%; (2) a glycol component comprising, for example, (a) about 95 to about 65 mol % 1,4-cyclohexanedimethanol, and (b) about 5 to about 50 mol % poly(oxytetramethylene) glycol, or 10 to 40 mol %, or 15 to 35 mol %, having a molecular weight for example, from about 500 to about 1200, or from 900 to 1,100, in both cases being weight average molecular weight.

Alternatively, the copolyester ethers may have an I.V., for example, from about 0.85 to about 1.4, or from 0.9 to 1.3, or from 0.95 to 1.2. As used herein, the I.V. is determined by dissolving a sample of the polymer in a solvent, measuring the flow rate of the solution through a capillary and then calculating the I.V. based on flow. Specifically, ASTM D4603-18, Standard Test Method for Determining Inherent Viscosity of Poly(Ethylene Terephthalate) (PET) by Glass Capillary Viscometer, may be used to determine I.V.

In addition to 1,4-cyclohexanedimethanol, other typical aliphatic or cycloaliphatic glycols having 2 to 10 carbon atoms that are useful in forming the copolyester ethers include those such as ethylene glycol, propylene glycol, 1,4-butanediol, neopentyl glycol 1,6-hexanediol, and 1,5-pentanediol, combinations thereof and the like. Although minor amounts of aromatic diols may be used, this may not be preferred.

In addition to polytetramethylene ether glycol, other useful polyether glycols having 2-4 carbon atoms between ether units include polyethylene ether glycol, and polypropylene ether glycol, and combinations thereof. Useful commercially available polyether glycols include Carbowax resins, Pluronics resins, and Niax resins. Polyether glycols useful according to the invention include those that may be characterized generally as polylakylene oxides, and may have a molecular weight, for example, from about 300 to about 10,000 or 500 to 2000.

The copolyester ethers further may comprise, for example, up to about 1.5 mol %, based on the acid or glycol component, of a polybasic acid or polyhydric alcohol branching agent having at least three —COOH or —OH functional groups and from 3 to 60 carbon atoms. Esters of many such acids or polyols may also be used. Suitable branching agents include trimellitic acid or anhydride, trimesic acid, trimethylol ethane, trimethylol propane, and trimer acid.

It should be understood that the total acid reactants should be 100%, and the total glycol reactants should be 100 mol %. Although the acid reactant is said to comprise 1,4-cyclohexanedicarboxylic acid, if the branching agent is a polybasic acid or anhydride, it will be calculated as part of the 100 mol % acid. Likewise, the glycol reactant is said to comprise 1,4-cyclohexanedimethanol and poly(oxytetramethylene) glycol, if the branching agent is a polyol, it will be calculated as part of the 100 mol % glycol.

The trans and cis isomer contents of the final copolyester ethers may be controlled in order to give polymers that setup or crystallize rapidly. Cis- and trans-isomer contents are measured by conventional methods known to those skilled in the art. See, for example, U.S. Pat. No. 4,349,469.

Especially suitable copolyester ethers used according to the invention are copolyester ethers based on 1,4-cyclohexanedicarboxylic acid, 1,4-cyclohexanedimethanol, and polytetramethylene ether glycol or other polyalkylene oxide glycol. In one aspect, the 1,4-cyclohexanedicarboxylic acid is present in an amount of at least 50 mol %, or at least 60 mol %, or at least 70 mol %, or at least 75 mol %, or at least 80 mol %, or at least 85 mol %, or at least 90 mol %, or at least 95 mol %, in each case based on the total amount of dicarboxylic acids present in the copolyester ether. In another aspect, the 1,4-cyclohexanedimethanol is present in an amount of from about 60 mol % to about 98 mol %, or from 65 mol % to 95 mol %, or from 70 mol % to 90 mol %, or from 75 mol % to 85 mol %, in each case based on the total amount of glycol. In another aspect, the polytetramethylene ether glycol is present in the copolyester ethers in an amount from about 2 to about 40 mol %, or from 5 mol % to 50 mol %, or from 7 mol % to 48 mol %, or from 10 mol % to 45 mol %, or from 15 to 40 mol %, or from 20 mol % to 35 mol %, in each case based on the total amount of glycol present.

In a further aspect, the amount of 1,4-cyclohexanedicarboxylic acid is from about 100 mol % to about 98 mol %, the amount of 1,4-cyclohexanedimethanol is from about 80 mol % to about 95 mol %, and the amount of polytetramethylene ether glycol is from about 5 mol % to about 20 mol %, and trimellitic anhydride may be present in an amount from 0.1 to 0.5 mol % TMA.

In a more specific aspect, the amount of 1,4-cyclohexanedicarboxylic acid is from 98 mol % to 100 mol %, the amount of 1,4-cyclohexanedimethanol is from 70 mol % to 95 mol %, and the amount of polytetramethylene ether glycol is from 5 mol % to 30 mol %, and trimellitic anhydride may be present in an amount from 0 to 0.5 mol %.

In yet another specific aspect, the amount of 1,4-cyclohexanedicarboxylic acid is from 99 mol % to 100 mol %, the amount of 1,4-cyclohexanedimethanol is from 70 mol % to 95 mol %, and the amount of polytetramethylene ether glycol is from 5 mol % to 30 mol %, and trimellitic ahydride may be present in an amount from 0 mol % to 1 mol %.

The copolyester ethers of the invention may include a phenolic antioxidant that is capable of reacting with the polymer intermediates. This causes the antioxidant to become chemically attached to the copolyester ether and be essentially nonextractable from the polymer. Antioxidants useful in this invention may contain one or more of an acid, hydroxyl, or ester group capable of reacting with the reagents used to prepare the copolyester ether. It is preferred that the phenolic antioxidant be hindered and relatively non-volatile. Examples of suitable antioxidants include hydroquinone, arylamine antioxidants such as 4,4′-bis(.alpha.,.alpha.-dimethylbenzyl)diphenylamine, hindered phenol antioxidants such as 2,6-di-tert-butyl-4-methylphenol, butylated p-phenyl-phenol and 2-(.alpha.-methylcyclohexyl)-4,6-dimethylphenol; bis-phenols such as 2,2′-methylenebis-(6-tert-butyl-4-methylphenol), 4,4′bis(2,6-di-tert-butylphenol), 4,4′-methylenebis(6-tert-butyl-2-methylphenol), 4,4′-butylene-bis(6-tert-butyl-3-methylphenol), methylenebis-(2,6di-tertbutylphenol), 4,4′-thiobis(6-tert-butyl-2-methylphenol), and 2,2′-thiobis(4-methyl-6-tert-butylphenol); tris-phenols such as 1,3,5-tris(3,5-di-tert-butyl-4-hydroxyhydrocinnamoyl)-hexahydro-s-triazine, 1,3,5-trimethyl-2,4,6-tris(3,5-di-tert-butyl-4-hydroxybenzyl)benzene and tri (3,5-di-tert-butyl-4-hydroxyphenyl)phosphite; and tetrakis[methylene(3,5-di-tert-butyl-4-hydroxyhydrocinnamate)methane] which is commercially available from Geigy Chemical Company as Irganox 1010 antioxidant, is preferred. Preferably, the antioxidant is used in an amount of from about 0.1 to about 1.0, based on the weight of copolyester ether.

Copolyester ethers of this invention include those characterized by their good melt strength. A polymer having melt strength is described as one capable of supporting itself on being extruded downward from a die in the melt. When a polymer with melt strength is extruded downward, the melt will hold together. When a polymer without melt strength is extruded downward, the melt rapidly drops and breaks. For purposes of comparison, the melt strength is measured at a temperature 20° C. above the melting peak.

Many useful applications can be envisioned for these blends in functional films such as paint protective films, automotive restyling films, graphic films, medical fabrics, breathable textiles, smart clothing, surface protective films, touch screen films, automotive interior surfacing films, laminating glass interlayers, tubing and hosing, belts and profiles, seals and gaskets. This list is by no means inclusive.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are intended to be reported precisely in view of methods of measurement. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the denomination of process steps, ingredients, or other aspects of the information disclosed or claimed in the application with letters, numbers, or the like is a convenient means for identifying discrete activities or ingredients and the recited lettering can be arranged in any sequence, unless otherwise indicated.

As used herein, the singular forms “a”, “an”, and “the” include plural referents unless the context clearly dictates otherwise. For example, reference to a Cn alcohol equivalent is intended to include multiple types of Cn alcohol equivalents. Thus, even use of language such as “at least one” or “at least some” in one location is not intended to imply that other uses of “a”, “an”, and “the” excludes plural referents unless the context clearly dictates otherwise. Similarly, use of the language such as “at least some” in one location is not intended to imply that the absence of such language in other places implies that “all” is intended, unless the context clearly dictates otherwise.

As used herein the term “and/or”, when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

This invention can be further illustrated by the following examples of embodiments thereof, although it will be understood that these examples are included merely for purposes of illustration and are not intended to limit the scope of the invention unless otherwise specifically indicated.

### EXAMPLES

To perform these experiments, several modified cap sheets were prepared by applying adhesives, both with and without TEGO Glide 410, to a standard cap sheet using a Techmaster coating device as set out in Table 1. The base cap sheet substrate was Skyrol SH40, produced by SKC Polyester film. Two different cap sheet adhesive layers were used: Adhesive A is ULTM (internally produced) and Adhesive B is Aroset 6082 (from Ashland Chemical), as laid out in Table 1.

Adhesives were prepared by mixing the ingredients listed in Table 1. Ingredients were homogenized using a stirrer for 5 minutes before applications. Adhesives were coated on a PET film, SH-40 supplied by SKC, on a 150 mm TecMaster™ to achieve 8-10 micron dry film thickness. The adhesives were nipped to U65 liner, supplied by Toray.

TABLE 1

| | Adhesive | Adhesive | Adhesive | Adhesive |
|---|---|---|---|---|
| Ingredient | A-1 | A-2 | B-1 | B-2 |
| Oribain BPS 5978 | 57 | 57 | | |
| Oribain BXX 5134 | 3 | 3 | | |
| Aroset 6082 | | | 62 | 62 |
| Tego Glide 410 | | 0.45 | | 0.57 |
| Ethyl Acetate | 26 | 26 | 28 | 28 |
| IPA | | | 3 | 3 |
| Toluene | 13 | 13 | 5 | 5 |
| n-butyl acetate | | | 2 | 2 |
| TOTAL | 100 | 100 | 100 | 100 |

Both example and comparative top coats Part A were prepared by mixing the ingredients listed in Table 2. The Part A and Part B were mixed together just before applying the film. Amounts of solvents, four parts of n-Butyl Acetate and one part of PM Acetate by weight, were adjusted to achieve desired formulation solids of 40 weight %. Adhesives were coated on a Argotec 49320 TPU (from SEM) on a 150 mm TecMaster™ to achieve 5-6 micron dry film thickness and were nipped to U65 liners coated with adhesives displayed in Table 1. Line speed and oven temperature were maintained at 0.5 ft/minute and 300 F respectively.

TABLE 2

| Expt# | CC1 | CC2 | CC3 | CC4 | CC5 | CC6 | CC7 |
|---|---|---|---|---|---|---|---|
| Part A | | | | | | | |
| Tetrashield 41268 | 100 | 100 | | | | | |
| Lumiflon LF 9721 | | | 100 | | | | |
| Silikotop 901 | | | | 100 | | | |
| Desmophen 670 BA | | | | | 100 | | |
| Tetrashield AC 1001 | | | | | | 100 | |
| Setalux 1903 | | | | | | | 100 |
| BYK Silclean-3700 | | 1.87 | 1.87 | 1.87 | 1.87 | 1.87 | 1.87 |
| DBTDL | 0.96 | 0.96 | 1.11 | 1.39 | 1.71 | 1.16 | 1.08 |
| Acetylacetone | 1.92 | 1.93 | 2.22 | 2.78 | 2.28 | 2.31 | 2.16 |
| N-Butyl Acetate | 68 | 67 | 81 | 117 | 92 | 90 | 79 |
| PM Acetate | 17 | 17 | 20 | 29 | 23 | 22 | 20 |
| Part B | | | | | | | |
| Desmodur N3300 | 26 | 26 | 41 | 58 | 33 | 40 | 38 |
| TOTAL | 214 | 215 | 247 | 310 | 254 | 258 | 241 |

Values of Total Surface Energies (SE) of both the modified cap sheets and a variety of functional films were measured. These values represent the surface of each film that are mated to the other film. The functional films each comprised a TPU film (Argotech 49320) onto which a coating had been applied, the different coatings being shown in Table 2. Some of the coatings contained BYK-Silkclean 3700 from BYK. In the table below, Table 3, values of the ratio of the surface energy of the cap sheet to the surface energy of the functional film are shown.

Roll to roll equipment was then used to nip these cap sheets onto a variety of functional films. The nipped/adhered films were then separated from each other on a mechanical testing machine and the peel force recorded. These data are also shown in Table 3. Peel strength values above 50 are considered high. In the comparative examples, we see that low ratio values lead to high peel strength values, which according to the invention, it is possible to have a relatively low ratio with desirably low peel strengths.

The data that follows shows surprising results obtained by use of TEGO Glide 410, a polyether siloxane copolymer produced by Evonik, as an additive in an adhesive layer on a cap sheet. Comparative examples CEX1 through CEX9 show expected behavior.

Moreover, the addition of Tego Glide 410 surprisingly increases the surface energy of the cap sheet. Similar additives, when used in the coating of the functional film, reduce their surface energies.

TABLE 3

| | | | | | | | Ratio of | |
|---|---|---|---|---|---|---|---|---|
| | | | | | | | Capsheet | |
| | | | | | | | Total SE | |
| | | | | | | | to | |
| | Functional Film | | | Capsheet | | | Functional | |
| | | Surface | Total SE | | | Total SE | Film Total | Peel |
| | Coating | additive | (dynes/cm) | Adhesive | Additive | (dynes/cm) | SE | strength |
| CEX1 | CC1 | No | 46.7 | A1 | No | 29.3 | 0.63 | 657 |
| CEX2 | CC2 | Yes | 19.0 | A1 | No | 29.3 | 1.54 | 115 |
| CEX3 | CC3 | Yes | 19.0 | A1 | No | 29.3 | 1.54 | 74 |
| CEX4 | CC4 | Yes | 19.1 | A1 | No | 29.3 | 1.53 | 98 |
| CEX5 | CC5 | Yes | 19.6 | A1 | No | 29.3 | 1.49 | 139 |
| CEX6 | CC6 | Yes | 19.0 | A1 | No | 29.3 | 1.54 | 182 |
| CEX7 | CC7 | Yes | 19.1 | A1 | No | 29.3 | 1.53 | 261 |
| CEX8 | CC1 | No | 46.7 | B1 | No | 9.7 | 0.21 | 1820 |
| CEX9 | CC2 | Yes | 19.0 | B1 | No | 9.7 | 0.51 | 1253 |
| CEX10 | CC3 | Yes | 19.0 | B1 | No | 9.7 | 0.51 | 282 |
| CEX11 | CC4 | Yes | 19.1 | B1 | No | 9.7 | 0.51 | 562 |
| CEX12 | CC5 | Yes | 19.6 | B1 | No | 9.7 | 0.49 | 1690 |
| CEX13 | CC6 | Yes | 19.0 | B1 | No | 9.7 | 0.51 | 1409 |
| CEX14 | CC7 | Yes | 19.1 | B1 | No | 9.7 | 0.51 | 1218 |
| EX1 | CC1 | No | 46.7 | A2 | Yes | 40.2 | 0.86 | 15 |
| EX2 | CC2 | Yes | 19.0 | A2 | Yes | 40.2 | 2.12 | 4 |
| EX3 | CC3 | Yes | 19.0 | A2 | Yes | 40.2 | 2.12 | 9 |
| EX4 | CC4 | Yes | 19.1 | A2 | Yes | 40.2 | 2.10 | 9 |
| EX5 | CC5 | Yes | 19.6 | A2 | Yes | 40.2 | 2.05 | 9 |
| EX6 | CC6 | Yes | 19.0 | A2 | Yes | 40.2 | 2.12 | 5 |
| EX7 | CC7 | Yes | 19.1 | A2 | Yes | 40.2 | 2.10 | 8 |
| EX8 | CC1 | No | 46.7 | B2 | Yes | 22.2 | 0.48 | 13 |
| EX9 | CC2 | Yes | 19.0 | B2 | Yes | 22.2 | 1.17 | 6 |
| EX10 | CC3 | Yes | 19.0 | B2 | Yes | 22.2 | 1.17 | 11 |
| EX11 | CC4 | Yes | 19.1 | B2 | Yes | 22.2 | 1.16 | 11 |
| EX12 | CC5 | Yes | 19.6 | B2 | Yes | 22.2 | 1.13 | 13 |
| EX13 | CC6 | Yes | 19.0 | B2 | Yes | 22.2 | 1.17 | 10 |
| EX14 | CC7 | Yes | 19.1 | B2 | Yes | 22.2 | 1.16 | 12 |

1. A functional film system, comprising:
a. a functional film having a surface energy; and
b. a cap sheet, adjacent to the functional film, having a surface energy, wherein the ratio of the surface energy of the cap sheet to the functional film, measured at a point where the cap sheet contacts the functional film, is no greater than 2.6.

2. The functional film system of claim 1, wherein the cap sheet comprises:
a. a cap sheet substrate, and
b. a cap sheet adhesive layer, adjacent to the functional film, which has the surface energy.

3. The functional film system of claim 1, wherein the ratio of the surface energy of the cap sheet to the functional film, measured at a point where the cap sheet contacts the functional film, is from about 0.1 to about 2.5.

4. The functional film system of claim 2, wherein the cap sheet adhesive layer comprises a surface-energy-modifying additive.

5. The functional film system of claim 4, wherein the surface-energy-modifying additive comprises one or more of: a fluoropolymer, a silicon-containing polymer, or an inorganic nanoparticle.

6. The functional film system of claim 4, wherein the surface-energy-modifying additive comprises one or more of: a polydimethylsiloxane, a polytetrafluoroethylene, a polyethylene, a polypropylene, an oxidized polyethylene, or an oxidized polypropylene.

7. The functional film system of claim 4, wherein the surface-energy-modifying additive comprises one or more polyether siloxane copolymers.

8. The functional film system of claim 4, wherein the surface-energy-modifying additive comprises a perfluoroalkyl-containing surfactant.

9. The functional film system of claim 1, wherein the functional film comprises a functional film substrate and a top coat, and wherein the top coat comprises a surface-energy-modifying additive.
